(19) United States
(12) Patent Application Publication
(10) Pub. No.: US 2004/0199484 A1
(43) Pub. Date: Oct. 7, 2004

(54) Decision tree analysis

(76) Inventors: Laurence Smith, Camberley (GB); John Tansley, Fleet (GB)

Correspondence Address: FISH & RICHARDSON P.C., 1425 K STREET, N.W., 11TH FLOOR, WASHINGTON, DC, 20005-3500, US

(21) Appl. No.: 10/406,836

(22) Filed: Apr. 4, 2003

(51) Int. Cl. G06N 5/02; G06F 9/44; G06N 7/02; G06N 7/06; G06F 17/00

(52) U.S. Cl. 706/52; 706/46

(57) ABSTRACT

A method of selecting a decision tree from multiple decision trees includes assigning a Bayesian tree score to each of the decision trees. The Bayesian tree score of each decision tree is compared and a decision tree is selected based on the comparison.

### TECHNICAL FIELD

This description relates to decision tree analysis.

### BACKGROUND

Decision trees are currently one of the most popular methods used for data modeling. They have the advantage of being conceptually simple, and have been shown to perform well on a variety of problems. Decision trees have many uses, such as, for example, predicting a probable outcome, assisting in the analysis of problems, and aiding in making decisions. When formulating and configuring decision trees, the results of real-world factors are analyzed and compiled, such that the specifics of the previous factors and related results are used to predict the results of future factors.

Unfortunately, for all but the simplest of decision trees, the potential number of tree configurations can be huge. For example, a decision tree may be generated to determine if a person has a low, medium, or high life expectancy. The factors analyzed may include, for example, whether the person is a smoker; the person's height; the person's weight, the person's gender, and the person's occupation. Since the branches of the decision tree (each of which represents a factor) may be configured in many different sequences, the number of potential decision trees quickly increases as the number of factors increases. Moreover, there are many different ways to learn decision trees, for example using only binary splits, versus accepting any number of splits.

It is therefore valuable to be able to compare the quality of multiple decision trees, generated from multiple decision tree learning algorithms. Currently, decision trees are compared by assessing their performance on some unseen data. This implies that given a finite amount of data, some must be kept aside (i.e., the test set) and not used for training.

### SUMMARY

In one general aspect, a method of selecting a decision tree, from multiple decision trees, includes assigning a Bayesian tree score to each of the decision trees. The Bayesian tree score of each decision tree is compared and a decision tree is selected based on the comparison.

Implementations may include one or more of the following features. For example, each of the decision trees may be generated, such that a first decision tree is generated using a default value of one or more user-defined parameters. Additional decision trees may be generated based on non-default values of the user-defined parameters. Examples of these user-defined parameters may include a node split probability, and a maximum split value.

Record sets may be received, each of which includes at least one input factor and at least one determined output factor. These record sets are used to generate the decision trees. The record sets may be stored on a database and receiving record sets may be configured to interface the decision tree selection method with the database.

Each decision tree may includes a primary node, and primary splitting variants are determined for the primary node and a Bayesian variant score is determined for each of the primary splitting variants. Determining primary splitting variants may include assigning a primary split probability to each primary splitting variant. Determining primary splitting variants may also include determining a likelihood score for each primary splitting variant. Determining primary splitting variants may also include processing the likelihood score and primary split probability of each primary splitting variant to determine the Bayesian variant score for each primary splitting variant. The primary splitting variant having the most desirable Bayesian variant score is selected.

The primary node is a primary leaf node, and assigning a Bayesian tree score may include determining, for a decision tree, a probability product that is equal to the probability of the selected primary splitting variant. Assigning a Bayesian tree score may include determining, for a decision tree, the Bayesian tree score that is equal to the mathematical product of the probability product and the likelihood score of the primary leaf node. The primary node may be a primary split node including branches, and a maximum number of split values for any input factor may be defined.

One or more of the decision trees may include one or more secondary nodes, such that each secondary node may be connected to a branch of a superior node. The superior node may be the primary node, or a superior secondary node.

Secondary splitting variants are determined for the secondary node and a Bayesian variant score for each of the secondary splitting variants. Determining secondary splitting variants may include assigning a secondary split probability to each secondary splitting variant. Determining secondary splitting variants may also include determining a likelihood score for each secondary splitting variant. Determining secondary splitting variants may also include processing the likelihood score and secondary split probability of each secondary splitting variant to determine the Bayesian variant score for each secondary splitting variant. The secondary splitting variant having the most desirable Bayesian variant score may be selected.

At least one secondary node may be a secondary leaf node, and assigning a Bayesian tree score may include determining, for a decision tree, a probability product that is equal to the mathematical product of the probabilities of the selected primary splitting variant and any selected secondary splitting variants. Assigning a Bayesian tree score may include determining, for a decision tree, the Bayesian tree score that is equal to the mathematical product of the probability product and the likelihood score of each secondary leaf node.

At least one secondary node may be a secondary split node including branches, and a maximum number of split values for any input factor may be defined. The superior node may be the primary node and the secondary splitting variants may exclude the primary splitting variant selected for the primary node. Alternatively, the superior node may be a superior secondary node and the secondary splitting variants may exclude the secondary splitting variant selected for the superior secondary node.

The above-described processes may be implemented as systems or sequences of instructions executed by a processor.

Other features will be apparent from the following description, including the drawings, and the claims.

### DESCRIPTION OF DRAWINGS

FIG. 1 is a block diagram of a computer network that may be used to implement a decision tree selection process.

FIG. 2 is a block diagram of a first decision tree.

FIG. 3 is a block diagram showing one implementation of the decision tree selection process.

FIG. 4 is a block diagram of a second decision tree.

FIG. 5 is a flowchart of a decision tree selection method.

### DETAILED DESCRIPTION

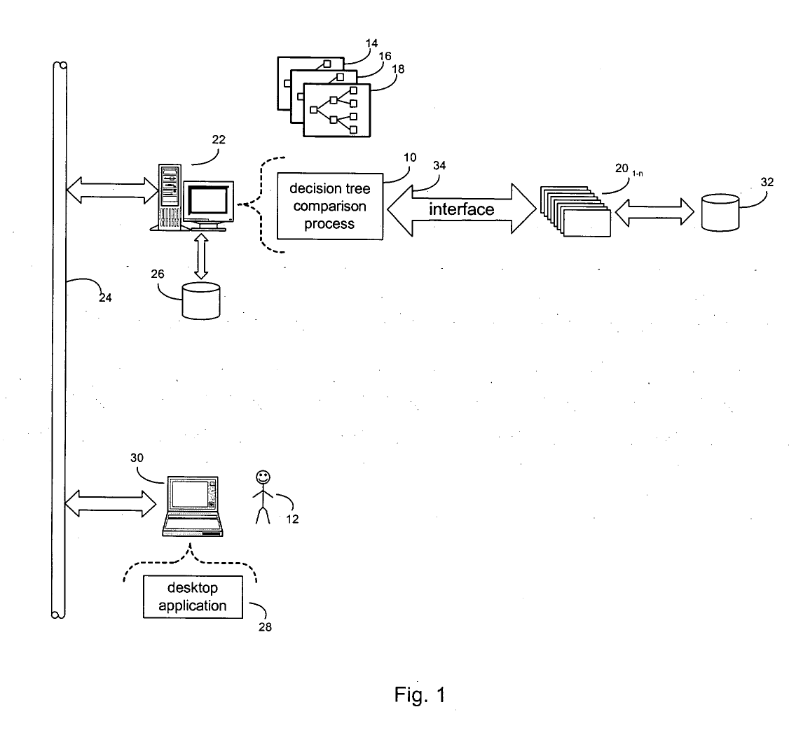

Referring to FIG. 1, a decision tree selection process 10 allows a user 12 to compare multiple decision trees 14, 16, and 18 that were compiled from database record sets 20₁₋ₙ. Decision tree selection process 10 determines a Bayesian score for each of the trees 14, 16, and 18, and allows user 12 to select one of the trees based on that Bayesian score.

Decision tree selection process 10 resides on and is executed by a computer 22 that is connected to a network 24 (e.g., the Internet, an intranet, a local area network, or some other form of network). The instruction sets and subroutines of decision tree selection process 10 are typically stored on a storage device 26 connected to computer 22. Storage device 26 may be, for example, a hard disk drive, a tape drive, an optical drive, a RAID array, a random access memory (RAM), or a read-only memory (ROM). User 12 may access and use decision tree selection process 10 through a desktop application 28 (e.g., Microsoft Internet Explorer™, Netscape Navigator™, or a specialized desktop interface) running on a computer 30 that is also connected to the network 24. Alternatively, user 12 may access decision tree selection process 10 directly through computer 22. During use, decision tree selection process 10 accesses user database 32 (on which database record sets 20₁₋ₙ are stored) through an interface process 34. Examples of user database 32 include Oracle™, Access™, and SQL™ databases. Interface process 34 includes the calls, procedures, and subroutines required to allow decision tree selection process 10 to access database record sets 20₁₋ₙ.

User database 32 includes record sets that concern an issue that the user has addressed in the past or is currently addressing (i.e., a historical record). These record sets may concern, for example, technical support issues (e.g., why has my computer locked up?), troubleshooting issues (e.g., why does my cable television not work?), loan statistics (e.g., what are my chances of getting a loan?), health statistics (e.g., what are my chances of getting health insurance?); or financial statistics (e.g., is my investment portfolio properly diversified?), for example. Typically, these recorded sets represent the previous experiences and results that were addressed by the client.

A typical group of record sets is the past loan-approval decisions that a bank has made based on two input factors (e.g., age, and homeownership status). An example of such a group of record sets is shown below:

| Record Number | Age of Applicant? | Homeowner? | Loan Awarded? |
|---|---|---|---|
| 1 | Low | Yes | Yes |
| 2 | Low | Yes | Yes |
| 3 | Low | Yes | Yes |
| 4 | Low | Yes | No |
| 5 | Low | Yes | No |
| 6 | Mid | Yes | Yes |
| 7 | Mid | Yes | Yes |
| 8 | Mid | Yes | Yes |
| 9 | Mid | Yes | Yes |
| 10 | Mid | Yes | Yes |
| 11 | Mid | Yes | Yes |
| 12 | Mid | Yes | Yes |
| 13 | Mid | Yes | Yes |
| 14 | Mid | Yes | Yes |
| 15 | Mid | Yes | Yes |
| 16 | High | Yes | Yes |
| 17 | High | Yes | Yes |
| 18 | High | Yes | Yes |
| 19 | High | Yes | Yes |
| 20 | Low | No | Yes |
| 21 | Low | No | No |
| 22 | Low | No | No |
| 23 | Low | No | No |
| 24 | Mid | No | Yes |
| 25 | Mid | No | Yes |
| 26 | Mid | No | No |
| 27 | Mid | No | No |
| 28 | Mid | No | No |
| 29 | Mid | No | No |
| 30 | Mid | No | No |
| 31 | High | No | Yes |
| 32 | High | No | Yes |
| 33 | High | No | No |
| 34 | High | No | No |
| 35 | High | No | No |
| 36 | High | No | No |
| 37 | High | No | No |
| 38 | High | No | No |

Since these record sets represent the loan decisions that a bank has made in the past based on two input factors, these record sets (if properly analyzed) should enable a loan officer of the bank to predict the loan-approval decision of a future loan applicant based on the value of that future applicant's two input factors. Typically, the field to be determined (i.e., the loan decision data field) is referred to as the determined output factor.

The above-described record sets can be summarized as follows:

| | Age (Low) | Age (Mid) | Age (High) |
|---|---|---|---|
| Homeowner (Yes) | 3 Loan, | 10 Loan, | 4 Loan, |
| | 2 No Loan | 0 No Loan | 0 No Loan |
| Homeowner (No) | 1 Loan, | 2 Loan, | 2 Loan, |
| | 3 No Loan | 5 No Loan | 6 No Loan |

During analysis, the record sets are manipulated to generate one or more decision trees, for example.

The record sets described above can be used to create a number of different decision trees, such that the number of trees is a function of the number of variables modified and the number of modification iterations. Accordingly, as the number of variables increases, the potential number of decision trees also increases. Additionally, as the number of iterations for each variable is increased, the potential number of decision trees further increases.

After (or while) the decision trees are generated, decision tree selection process 10 calculates a Bayesian score for each of these decision trees.

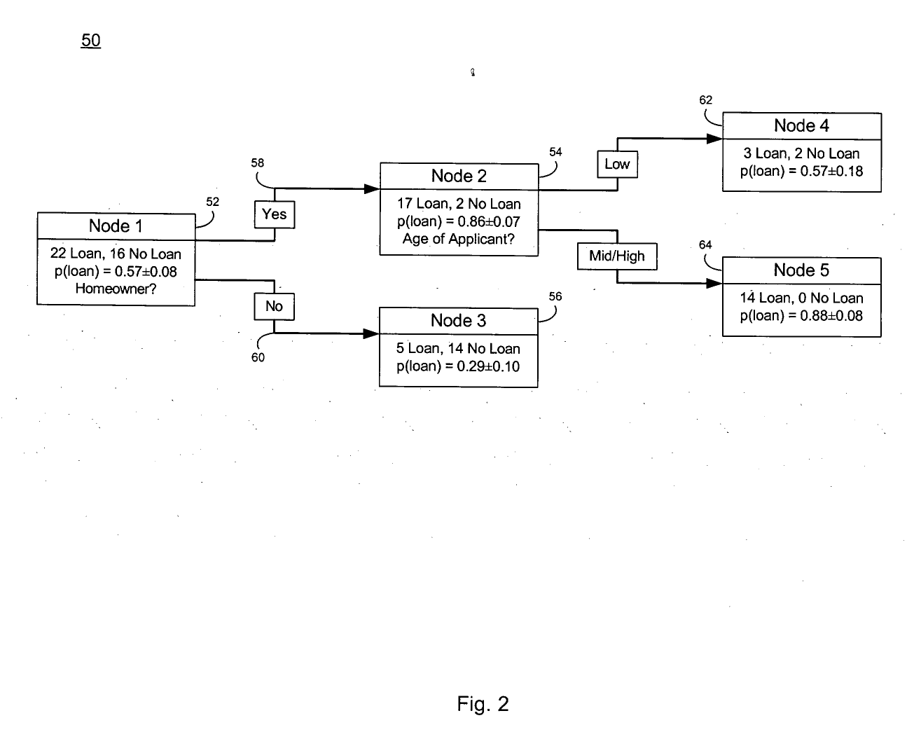

Referring to FIG. 2, a decision tree 50 includes a primary node 52 (i.e., a root node) that is the starting node of the decision tree. Primary node 52 is referred to as a root node since it is the base of the decision tree (i.e., having no parent nodes) and contains all data sets. Decision tree 50 represents one of the many possible decision trees that can be generated from the above-described record sets.

The primary node 52 represents the record sets prior to splitting on that node. During the splitting process, this node is termed the primary node, and any further nodes generated by splitting are termed secondary nodes. When a primary node is split, all record sets contained by the primary node are split amongst the secondary nodes created. For this particular example, there are thirty-eight record sets, of which twenty-two applicants received loans and sixteen applicants were denied loans.

The following equation defines the probability associated with a node:

$${p}_{i} = \frac{{n}_{i} + 1}{ND + NC} \qquad [ 1 ]$$

where

$$ND = {\sum }_{i = 1}^{NC} {n}_{i}$$

is the total number of data points, NC is the number of target categories (i.e., the number of potential answers for the determined output factor), and nᵢ is the number of record sets for each output value. For these record sets, the loan can either be approved or declined. Therefore, NC=2.

The error in these probabilities is defined by the following equation:

$${σ}_{i} = \sqrt{\frac{{p}_{i} \cdot ( 1 - {p}_{i} )}{ND + NC + 1}} \qquad [ 2 ]$$

Inserting the values for primary node 52 into equations 1 and 2 produces the following results:

$${p}_{Loan} = \frac{22 + 1}{38 + 2} = 0.575 \qquad ( from [ 1 ] )$$

with an error estimate of:

$${σ}_{Loan} = \sqrt{\frac{{p}_{Loan} \cdot ( 1 - {p}_{Loan} )}{38 + 2 + 1}} = \sqrt{\frac{0.575 \cdot ( 1 - 0.575 )}{38 + 2 + 1}} \approx 0.0772 \qquad ( from [ 2 ] )$$

Note that if we had more than two target categories, similar probabilities and errors could be generated for each target category. As we have only two categories here, generating a single probability and error is sufficient for the purposes of example.

The probability and error functions for Nodes 2-5 are calculated in a similar fashion. Note that these probability and error functions are not required for decision tree selection process 10 to function properly, and these functions are explained solely to aid in the understanding of decision trees.

As stated above, primary node 52 represents the record sets prior to splitting the data at that node. Note that while decision tree 50 is shown as a completed tree, this is for illustrative purposes only. Instead of including multiple figures, with each illustrating decision tree 50 at various states of completion, a single figure was used to show the entire tree. How the configuration of decision tree 50 was determined is discussed below.

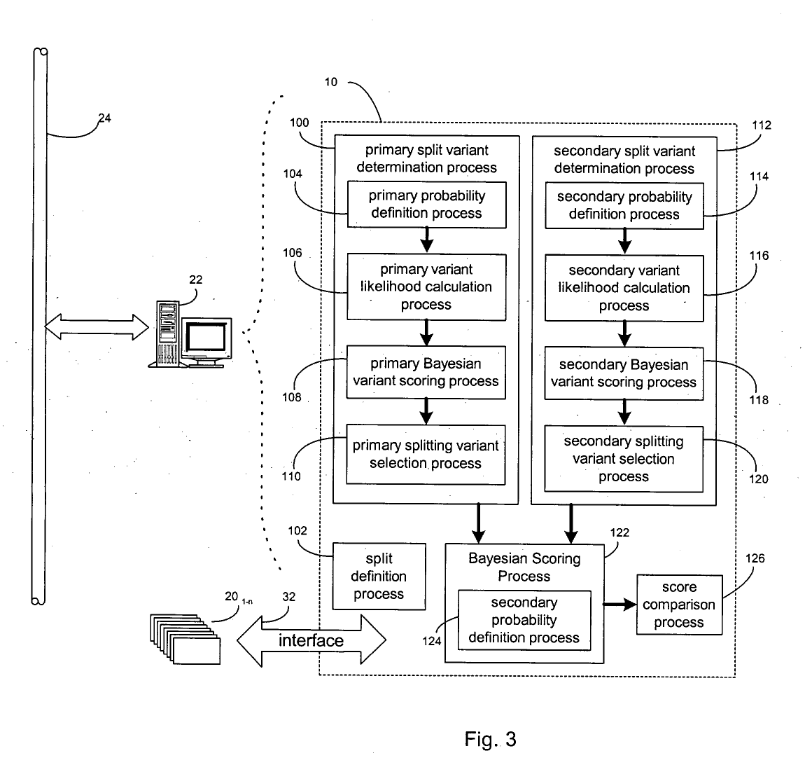

Referring to FIGS. 2 and 3, decision tree selection process 10 includes a primary split variant determination process 100 for determining primary splitting variants for primary node 52. A Bayesian variant score (to be explained below) is also determined for each of the primary splitting variants. Each primary splitting variant represents one of the possible manners in which primary node 52 can be split. For this particular example, primary node 52 can split as follows: (a) no split; (b) split based on homeownership; or (c) split based on age.

Since, unlike homeownership, age has three possible values (i.e., low, mid, and high), age can be split in several fashions, such as (a) low, mid, or high; (b) low or mid/high; (c) low/mid or high; or (d) low/high or mid. Since most fields do not tend to be binary (i.e., having only two states or values), it may be desirable to limit the number of possible splits that a node can make. For example, suppose that the “age” field was listed in years, as opposed to the easily-manageable low/mid/high. It would be possible to have seventy or eighty possible values for that field.

Accordingly, decision tree selection process 10 includes a split definition process 102 for defining a maximum number of split values for any input factor (i.e., input field). For example, since the age field has three possible values, namely low, mid, and high, there are three possible ways (i.e., split values) in which the primary node may split. However, if split definition process 102 was configured so that a field cannot be split into more than two possible values at a single node, the age field would have to be split in one of three ways, namely (a) low/mid or high, (b) low or mid/high, or (c) low/high or mid.

For ease of illustration, it is assumed that the user of decision tree selection process 10 set the maximum number of values for any input factor equal to two. Accordingly, primary split variant determination process 100 determines the following primary splitting variants: (a) no split; (b) split on homeownership; (c) split on age low/mid or high; and (d) split on age low or mid/high. While, as described above, there is a third possibility for splitting on age (i.e., low/high or mid), for ease of illustration, the description will be limited to the two possible age splits stated above.

Primary split variant determination process 100 includes a primary probability definition process 104 for assigning a primary split probability to each of the primary splitting variants. Typically, probabilities are evenly distributed. However, as discussed below, the distribution can be varied as desired by the user.

As stated above, there are four primary splitting variants, namely: (a) no split; (b) split on homeownership; (c) split on age low/mid or high; and (d) split on age low or mid/high. Accordingly, the first probability is whether the primary node 52 will split. Assigning an even probability, the probability of splitting is 50% and the probability of not splitting is also 50% (as these are the only two possibilities). If the primary node splits (for which there is a 50% probability), there is a 25% chance it will split based on homeownership and a 25% chance it will split based on age. Again, this assumes an even probability distribution. If the primary node splits based on age (for which there is a 25% chance), there is a 12.5% chance that it will split based on the low/mid or high variant, and a 12.5% chance that it will split based on the low, or mid/high variant. Summing up, the four probabilities that are based on the four primary splitting variants are:

| | |
|---|---|
| probability (No Split) | 50.0% |
| probability (Split on Homeowner) | 25.0% |
| probability (Split on low/mid or high) | 12.5% |
| probability (Split on low or mid/high) | 12.5% |

These probabilities can be adjusted as desired by the user. For example, if the user considered the low/mid, high age split to be more important than the low, mid/high age split, the user could have adjusted these values accordingly (e.g., the user could adjust the probability so that the low/mid, high split had a probability of 20% and the low, mid/high split had a probability of 5%).

Once the probabilities are determined, a primary variant likelihood calculation process 106 can determine a likelihood score for each of the four primary splitting variants. The following equation defines the likelihood score for each of the primary splitting variants:

$$L = \frac{( NC - 1 ) ! \cdot {\prod }_{i = 1}^{NC} {n}_{i} !}{( ND + NC - 1 ) !} \qquad [ 3 ]$$

Accordingly, the variant “probability (No Split)” has a likelihood score of:

$${L}_{NoSplit} = \frac{( NC - 1 ) ! \cdot {\prod }_{i = 1}^{NC} {n}_{i} !}{( ND + NC - 1 ) !} = \frac{( 2 - 1 ) ! \cdot 22 ! \cdot 16 !}{( 38 + 2 - 1 ) !} \approx 1.15 e - 12 \qquad from [ 3 ]$$

Since the variant “probability (no split)” will result in no further record sets (as the data is not going to be split), equation (3) only takes into account one set of data, namely thirty-eight record sets, of which twenty-two applicants received loans and sixteen applicants were denied loans.

The variant “probability (Split on Homeowner)” must be calculated a little differently, as this variant results in two sets of data, one for homeowners and one for non-homeowners. These two subsets are seventeen “loan” and two “no loan” for homeowners, and five “loan” and fourteen “no loan” for non-homeowners.

As the data is split into two sets, the likelihood of the split model is defined as the product of the likelihoods of each of the new subsets:

$${L}_{Split using Homeowner} = \frac{( 2 - 1 ) ! \cdot 17 ! \cdot 2 !}{( 19 + 2 - 1 ) !} \cdot \frac{( 2 - 1 ) ! \cdot 5 ! \cdot 14 !}{( 19 + 2 - 1 ) !} \approx 1257 e - 12 \qquad from [ 3 ]$$

The variant “probability (Split on low/mid or high) again results in two sets of data, with the first being sixteen “loan” and ten “no loan” for an age of low/mid, and the second being six “loan” and six “no loan” for an age of high:

$${L}_{Split using LM or H} = \frac{16 ! \cdot 10 !}{( 26 + 2 - 1 ) !} \cdot \frac{6 ! \cdot 6 !}{( 12 + 2 - 1 ) !} \approx 0.580 e - 12 \qquad from [ 3 ]$$

The variant “probability (Split on low or mid/high) again results in two sets of data, with the first being four “loan” and five “no loan” for an age of low, and the second being eighteen “loan” and eleven “no loan” for an age of mid/high:

$${L}_{Split using L or M H} = \frac{4 ! \cdot 5 !}{( 9 + 2 - 1 ) !} \cdot \frac{18 ! \cdot 11 !}{( 29 + 2 - 1 ) !} \approx 0.765 e - 12 \qquad from [ 3 ]$$

Summing up the likelihood calculations and expanding the above-listed table results in the following:

| Variant | Probability | Likelihood |
|---|---|---|
| probability (No Split) | 50.0% | 1.15e−12 |
| probability (Split on Homeowner) | 25.0% | 1257e−12 |
| probability (Split on low/mid or high) | 12.5% | 0.580e−12 |
| probability (Split on low or mid/high) | 12.5% | 0.765e−12 |

Once the likelihoods are determined, a primary Bayesian variant scoring process 108 can determine a Bayesian variant score for each of the primary splitting variants, based on the likelihood and probability of that variant. Specifically, the Bayesian variant score for each variant is equal to the product of the probability and the likelihood. Accordingly, the Bayesian variant score for each of the variants is as follows:

| Variant | Probability | Likelihood | Bayesian Score |
|---|---|---|---|
| probability (No Split) | 50.0% | 1.15e−12 | 0.575e−12 |
| probability (Split on | 25.0% | 1257e−12 | 314.25e−12 |
| Homeowner) | | | |
| probability (Split on | 12.5% | 0.580e−12 | 0.0725e−12 |
| low/mid or high) | | | |
| probability (Split on | 12.5% | 0.765e−12 | 0.0956e−12 |
| low or mid/high) | | | |

Now that the Bayesian variant scores are determined, a primary splitting variant selection process 110 selects the primary splitting variant having the most desirable Bayesian variant score. Typically, this is the highest Bayesian variant score. Therefore, as the variant “probability (Split on Homeowner)” has the highest Bayesian score, the primary splitting variant selection process 110 will select that variant. Accordingly, primary node 52 of decision tree 50 will be configured to initially split based on whether the applicant is a homeowner. This split results in two additional nodes, namely secondary node 54 and secondary node 56. Nodes 54 and 56 are referred to as secondary nodes since they are not the primary (i.e., starting) node in the decision tree. Accordingly, a secondary node is located “downstream” from a primary node or another secondary node.

As primary node 52 splits into multiple branches (i.e., two branches 58 and 60), these nodes are often referred to as “branching” or “splitting” nodes. As will be discussed below in greater detail, nodes that do not split are generally referred to as “leaf” nodes.

Note that secondary node 54 (i.e., Node 2) lists record statistics of seventeen “loans” and two “no loans.” Further, secondary node 56 (i.e., Node 3) lists record statistics of five “loans” and fourteen “no loans.” Summing these two sets of statistics yields twenty-two “loans” and sixteen “no loans,” which is equal to the statistics of primary node 52 (i.e., Node 1).

Now that primary node 52 was split into two secondary nodes (i.e., nodes 54 and 56), each of these nodes must be examined to determine if they can be split based on age. Specifically, the records corresponding to the secondary nodes were already split in accordance with their homeownership status. Accordingly, if they are to split again, they can only be split in accordance with age.

This splitting determination process is recursive, in that each new node created is subsequently examined to determine if it can be split again. As will be discussed below in greater detail, this-recursive splitting continues until every node that needs to be split is split. Mathematically, a node needs to be split whenever the Bayesian score of the “no split” variant is less than that of any other variant. In other words, only when the “no split” variant has the highest Bayesian score should that node not be split.

As discussed above, split definition process 102 was used to define a maximum number of split values for any input factor (i.e., input field). Accordingly, for ease of illustration, the age field will again be split in one of two ways, namely (a) low/mid or high, or (b) low or mid/high.

Decision tree selection process 10 includes a secondary split variant determination process 112 for determining secondary splitting variants for the secondary nodes (e.g., secondary node 54) and the Bayesian variant score for each of the secondary splitting variants. Each secondary splitting variant represents one of the possible manners in which the secondary node can be split. For this particular example, secondary node 54 can be split as follows: (a) no split or (b) split based on age. Note that the secondary node 54 cannot be split based on homeownership, as it was already split based on homeownership. As discussed above, splitting on age will be limited to one of two scenarios, namely (1) low/mid or high, or (2) low or mid/high. Accordingly, secondary split variant determination process 112 determines the following secondary splitting variants: (a) no split; (b) split on age low/mid or high; and (c) split on age low or mid/high.

Secondary split variant determination process 112 includes a secondary probability definition process 114 for assigning a secondary split probability to each of the secondary splitting variants. As above, probabilities are typically evenly distributed. However, the distribution can be varied as desired by the user.

As stated above, there are three secondary splitting variants, namely: (a) no split; (b) split on age low/mid or high; and (c) split on age low or mid/high. Accordingly, the first probability is whether secondary node 54 will split. Again assigning an even probability, the probability of splitting is 50% and the probability of not splitting is also 50% (i.e., the only two possibilities). If the secondary node splits (for which there is a 50% probability), there is a 25% chance that the split will be based on the low/mid or high age variant, and a 25% chance that the split will be based on the low or mid/high age variant. Summing up, the three probabilities that are based on the three secondary splitting variants are:

| | |
|---|---|
| probability (No Split) | 50.0% |
| probability (Split on low/mid or high) | 25.0% |
| probability (Split on low or mid/high) | 25.0% |

As discussed above, these probabilities can be adjusted as desired by the user, such as for example, setting the low/mid and high split to have a probability of 10% and the low and mid/high split to have a probability of 40%.

Once the probabilities are determined, a secondary variant likelihood calculation process 5116 determines a likelihood score for each of the three secondary splitting variants.

Accordingly, the variant “probability (No Split)” has a likelihood score of:

$${L}_{NoSplit} = \frac{( NC - 1 ) ! \cdot {\prod }_{i = 1}^{NC} {n}_{i} !}{( ND + NC - 1 ) !} = \frac{( 2 - 1 ) ! \cdot 17 ! \cdot 2 !}{( 19 + 2 - 1 ) !} \approx 0.292 ⅇ - 3 \qquad from [ 3 ]$$

As explained above, since the variant “probability (no split)” will result in no further record sets (as the data is not going to be split), equation (3) only takes into account one set of data, namely nineteen record sets, of which seventeen applicants received loans and two applicants were denied loans.

The variant “probability (Split on low/mid or high) again results in two sets of data, with the first being thirteen “loan” and two “no loan” for an age of low/mid, and the second being four “loan” and zero “no loan” for an age of high:

$${L}_{Split using LM or H} = \frac{13 ! \cdot 2 !}{( 15 + 2 - 1 ) !} \cdot \frac{4 ! \cdot 0 !}{( 4 + 2 - 1 ) !} \approx 1.119 ⅇ - 3 \qquad from [ 3 ]$$

The variant “probability (Split on low or mid/high) again results in two sets of data, with the first being three “loan” and two “no loan” for an age of low, and the second being fourteen “loan” and zero “no loan” for an age of mid/high.

$${L}_{Split using L or MH} = \frac{3 ! \cdot 2 !}{( 5 + 2 - 1 ) !} \cdot \frac{14 ! \cdot 0 !}{( 14 + 2 - 1 ) !} \approx 1.111 ⅇ - 3 \qquad from [ 3 ]$$

Summing up the likelihood calculations and expanding the above-listed table results in the following:

| Variant | Probability | Likelihood |
|---|---|---|
| probability (No Split) | 50.0% | 0.292e−3 |
| probability (Split on low/mid or high) | 25.0% | 0.119e−3 |
| probability (Split on low or mid/high) | 25.0% | 1.111e−3 |

Once the likelihoods are determined, a secondary Bayesian variant scoring process 118 can determine a Bayesian variant score for each of the secondary splitting variants, based on the likelihood and probability of that variant. As above, the Bayesian variant score for each variant is equal to the product of the probability and the likelihood. Accordingly, the Bayesian variant score for each of the variants is as follows:

| Variant | Probability | Likelihood | Bayesian Score |
|---|---|---|---|
| probability (No Split) | 50.0% | 0.292e−3 | 0.146e−3 |
| probability (Split on | 25.0% | 0.119e−3 | 0.030e−3 |
| low/mid or high) | | | |
| probability (Split on | 25.0% | 1.111e−3 | 0.278e−3 |
| low or mid/high) | | | |

Now that the Bayesian variant scores are determined, a secondary splitting variant selection process 120 selects the secondary splitting variant having the most desirable Bayesian variant score. As above, this is typically the highest Bayesian variant score. Therefore, as the variant “probability (Split on low or mid/high)” has the highest Bayesian score, the secondary splitting variant selection process 120 will select that variant. Accordingly, secondary node 54 of decision tree 50 will be configured to split into two branches based on whether the applicant's age is “low” or “mid/high.” This split results in two additional secondary nodes, namely secondary node 62 and secondary node 64. As explained above, nodes 62 and 64 are also referred to as secondary nodes since they are not the primary node in the decision tree and are, therefore, located downstream from another node (i.e., secondary node 54).

Note that these nodes, by definition, cannot be split any further, as they have already been split in accordance with homeownership and age (based on a low, or mid/high splitting value set). Accordingly, nodes 62 and 64 are referred to as “leaf” nodes,” as opposed to “branching” or “splitting” nodes 52 and 54.

Theoretically, it may be possible to split secondary node 64 into two nodes, namely a node for age “mid” and a node for age “high.” However, age was previously defined as having two possible split values, namely “low” or “mid/high.” If this potential split was going to be investigated, as above, the split variants (i.e., “no split”, and “split age mid or high”) would need to be defined, probabilities would need to be assigned to each variant (e.g., 50%, and 50%) and likelihoods and Bayesian scores would need to be calculated.

Note that secondary node 62 (i.e., Node 4) lists record statistics of three “loans” and two “no loans,” while secondary node 64 (i.e., Node 5) lists record statistics of fourteen “loans” and zero “no loans”. Summing these two sets of statistics yields seventeen “loans” and two “no loans,” which is equal to the statistics of secondary node 54 (i.e., Node 2), the node from which both of these nodes originate.

As stated above, the process of analyzing nodes to determine if they can be split is recursive in nature, in that the nodes are analyzed until no additional splitting is possible. Accordingly, while no further splitting is possible for nodes 62 and 64 (i.e., Node 4 and Node 5), it still may be possible to split secondary node 56 (i.e., Node 3) based on age, as the data in this node has already been split based on homeownership status.

For secondary node 56, there are three secondary splitting variants, namely: (a) no split; (b) split on age low/mid or high; and (c) split on age low or mid/high. Assigning an even probability, the probability of splitting is 50% and the probability of not splitting is also 50%. If the secondary node splits (for which there is a 50% probability), there is a 25% chance that it will split based on the low/mid or high age variant, and a 25% chance that it will split based on the low or mid/high age variant. Summing up, the three probabilities that are based on the three secondary splitting variants are:

$$\begin{matrix}probability ( No Split ) & 50.0 \% \\ probability ( Split on low \text{/} mid or high ) & 25.0 \% \\ probability ( Split on low , or mid \text{/} high ) & 25.0 \%\end{matrix}$$

Again, these probabilities can be adjusted as desired by the user. Once the probabilities are determined, the secondary variant likelihood calculation process 116 determines a likelihood score for each of the three secondary splitting variants.

Accordingly, the variant “probability (No Split)” has a likelihood score of:

$${L}_{NoSplit} = \frac{( NC - 1 ) ! \cdot {\prod }_{i = 1}^{NC} {n}_{i} !}{( ND + NC - 1 ) !} = \frac{( 2 - 1 ) ! \cdot 5 ! \cdot 14 !}{( 19 + 2 - 1 ) !} \approx 4.30 ⅇ - 6 \qquad from [ 3 ]$$

The variant “probability (Split on low/mid or high) has a likelihood score of:

$${L}_{Split using LM or H} = \frac{3 ! \cdot 8 !}{( 11 + 2 - 1 ) !} \cdot \frac{2 ! \cdot 6 !}{( 8 + 2 - 1 ) !} \approx 2.00 ⅇ - 6 \qquad from [ 3 ]$$

The variant “probability (Split on low or mid/high) has a likelihood score of:

$${L}_{Split using L or MH} = \frac{1 ! \cdot 3 !}{( 4 + 2 - 1 ) !} \cdot \frac{4 ! \cdot 11 !}{( 15 + 2 - 1 ) !} \approx 2.29 ⅇ - 6 \qquad from [ 3 ]$$

Summing up the likelihood calculations and expanding the above-listed table results in the following:

| Variant | Probability | Likelihood |
|---|---|---|
| probability (No Split) | 50.0% | 4.30e−6 |
| probability (Split on low/mid or high) | 25.0% | 2.00e−6 |
| probability (Split on low or mid/high) | 25.0% | 2.29e−6 |

As discussed above, once the likelihoods are determined, a secondary Bayesian variant scoring process 118 determines a Bayesian variant score for each of the secondary splitting variants based on the likelihood and probability of that variant. The Bayesian variant score for each variant is equal to the product of the probability and the likelihood. Accordingly, the Bayesian variant score for each of the variants is as follows:

| Variant | Probability | Likelihood | Bayesian Score |
|---|---|---|---|
| probability (No Split) | 50.0% | 4.30e−6 | 2.15e−6 |
| probability (Split on | 25.0% | 2.00e−6 | 0.50e−6 |
| low/mid or high) | | | |
| probability (Split on | 25.0% | 2.29e−6 | 0.57e−6 |
| low, or mid/high) | | | |

Now that the Bayesian variant scores are determined, a secondary splitting variant selection process 120 selects the secondary splitting variant having the most desirable Bayesian variant score. Typically, this is the highest Bayesian variant score. As “probability (No Split)” has the highest Bayesian score, this node will not be split and is referred to as a leaf node. Since no other nodes in decision tree 50 are capable of splitting, decision tree 50 is complete.

As decision tree 50 is now complete, a Bayesian score can be determined for the decision tree as a whole. Bayesian scoring process 122 includes a node probability product process 124 for determining a probability product for decision tree 50. The probability product is equal to the mathematical product of the probabilities of the selected splitting variants (i.e., both primary and secondary splitting variants). For nodes that are incapable of splitting (e.g., secondary nodes 62 and 64), the probability of these nodes not splitting is 100%. For decision tree 50, the probability product p(tree 50) is equal to the product of the probabilities of (Node 1: split on homeowner); (Node 2: split on age L, M/H); (Node 3: no split); (Node 4: no split); and (Node 5: no split). Accordingly, this probability product is as follows:

Probability Productp(tree 50)=(0.25)*(0.25)*(0.5)*(1)*(1)=0.03125

Bayesian scoring process 122 determines the Bayesian score of the decision tree 50 by determining the product of the probability product p(tree 50) and the likelihood of any leaf nodes within the tree. As explained above, a leaf node is a node within the tree that mathematically cannot be split any further. Secondary nodes 56, 62 and 64 are all leaf nodes because it was mathematically determined that they could not be split. Concerning node 56, while it was possible that the node could be split based on age (i.e., there were three variants), as shown above, it was determined that mathematically node 56 could not be split. By contrast, nodes 62 and 64 each only had one variant (i.e., no split) due to the fact that the data of these nodes were already split based on homeownership and age. Accordingly, the probability of the single variant was 100% and, therefore, the only option was not to split.

The likelihood of secondary node 62 (i.e., Node 4) and secondary node 64 (i.e., Node 5) are calculated as follows:

$$\begin{matrix}{L}_{Node3} = \frac{( NC - 1 ) ! \cdot {\prod }_{i = 1}^{NC} {n}_{i} !}{( ND + NC - 1 ) !} = \frac{( 2 - 1 ) ! \cdot 5 ! \cdot 14 !}{( 19 + 2 - 1 ) !} \approx 4.30 ⅇ - 6 & from [ 3 ]\end{matrix} \begin{matrix}{L}_{Node4} = \frac{( NC - 1 ) ! \cdot {\prod }_{i = 1}^{NC} {n}_{i} !}{( ND + NC - 1 ) !} = \frac{( 2 - 1 ) ! \cdot 3 ! \cdot 2 !}{( 5 + 2 - 1 ) !} \approx 16.67 ⅇ - 3 & from [ 3 ]\end{matrix} \begin{matrix}{L}_{Node5} = \frac{( NC - 1 ) ! \cdot {\prod }_{i = 1}^{NC} {n}_{i} !}{( ND + NC - 1 ) !} = \frac{( 2 - 1 ) ! \cdot 14 ! \cdot 0 !}{( 14 + 2 - 1 ) !} \approx 6.67 ⅇ - 2 & from [ 3 ]\end{matrix}$$

Concerning decision tree 50, the Bayesian tree score is:

$$\begin{matrix}Bayesian Tree Score = p ( tree 50 ) * L ( Node 3 ) * L ( Node 4 ) * L ( Node 5 ) \\ = ( 0.03125 ) * ( 4.300 ⅇ - 6 ) * ( 16.67 ⅇ - 3 ) * ( 6.67 ⅇ - 2 ) \\ = 14.93 ⅇ - 12\end{matrix}$$

Accordingly, the Bayesian tree score for decision tree 50 is 149.3e-12. As decision tree selection process 10 compares the Bayesian scores of multiple decision trees in order to determine the tree that best matches the data set, another tree will be constructed to make the comparison. Multiple trees are created from a common data set by making adjustments to the variables settable by the user. For example, in decision tree 50, the probabilities were always evenly split. However, as discussed above, these probabilities may be adjusted as desired by the user. Accordingly, if these variations were made and the above-described processes rerun, a different decision tree would be generated. Further, as discussed above, the user can use split definition process 102 to specify the maximum number of split values for any input factor. As discussed above, the field “age” which had three possible values (i.e., low, mid, high) was only allowed to split into two possible split values (i.e., either low and mid/high, or low/mid and high). Again, if node 54 was allowed to split three ways (i.e., low, mid, high), a different tree would be created. As could be imagined, as the number of fields in a data set increases, and the number of possible values in each of those fields also increases, the maximum number of decision trees that can be created increases quite rapidly.

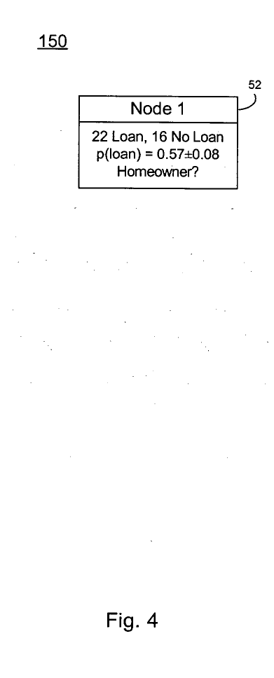

FIG. 4 shows a second decision tree 150. For this second decision tree, the split probably for primary node 152 is set to 0%. Accordingly, there is a 100% probability that primary node 152 will not split. As discussed above, this probability, which is set by primary probability definition process 104, can be set to any value designated by the user. The calculations concerning primary node 152 are carried out in the same fashion as those described above. Accordingly, the variants, and their related probabilities, likelihoods, and Bayesian scores for node 152 are:

| Variant | Probability | Likelihood | Bayesian Score |
|---|---|---|---|
| probability (No Split) | 100.0% | 1.15e−12 | 1.15e−12 |
| probability (Split on | 0.0% | 1257e−12 | 0 |
| Homeowner) | | | |
| probability (Split on | 0.0% | 0.580e−12 | 0 |
| low/mid or high) | | | |
| probability (Split on | 0.0% | 0.765e−12 | 0 |
| low or mid/high) | | | |

As would be expected, the Bayesian score of the “no split” variant is the largest. Accordingly, decision tree 150 is a simple tree comprising only one node (i.e., primary node 152), which is also a leaf node since it mathematically cannot split.

Now that decision tree 150 is complete, Bayesian scoring process 120 will determine a Bayesian tree score for tree 150 by determining the product of the probability product “p(tree 150)” and the likelihood of any leaf nodes within the tree. As discussed above, the probability product is equal to the mathematical product of the probabilities of the selected splitting variants (i.e., both primary and secondary splitting variants). For decision tree 150, the probability product p(tree 150) is equal to the product of the probabilities of (Node 1: no split). Accordingly, this probability product is as follows:

Probability Product p(tree 150)=1.0

Bayesian scoring process 122 then determines the Bayesian score of decision tree 150 by determining the product of the probability product p(tree 150) and the likelihood of any leaf nodes within the tree. Since there is only one leaf node (i.e., primary node 150), the Bayesian tree score is determined as follows:

$$\begin{matrix}Bayesian Tree Score = p ( tree 150 ) * L ( Node 1 ) \\ = ( 1.00 ) * ( 1.15 ⅇ - 12 ) \\ = 1.15 ⅇ - 12\end{matrix}$$

Accordingly, now there are two separate decision trees that can be compared, namely decision tree 50 and decision tree 150, with the difference between the trees being that decision tree 50 was based on a split probability of 50%, while decision tree 150 was based on a split probability of 0%. The Bayesian scores for these two trees are as follows:

| | p(split) | Bayesian Tree Score |
|---|---|---|
| Decision Tree 50 | 50% | 149.3e−12 |
| Decision Tree 150 | 0% | 1.15e−12 |

Once the production and analysis of decision trees is complete, the Bayesian score of each decision tree is compared by a score comparison process 126 to determine which of the decision trees (i.e., trees 50 and 150) has the most desirable Bayesian tree score. As shown above, decision tree 50 has a better Bayesian score and, therefore, decision tree 50 more closely represents the data that the user is analyzing (i.e., record sets 20₁₋ₙ).

While the comparison described above illustrates a situation in which the most desirable Bayesian tree score is selected, other configuration are possible. As explained above, a very large number of decision tree may be generated for larger record sets. According, it may be difficult and time consuming to generate and score each and every possible decision tree. Therefore, score comparison process 126 may be configured so that decision trees are repeatedly generated and scored until a tree with a Bayesian score meeting or exceeding a desired Bayesian score threshold is generated. At this point, that tree would be selected and the generation and scoring of decision trees would stop. Accordingly, the most desirable Bayesian tree score may be defined as a range of scores, as opposed to the highest score.

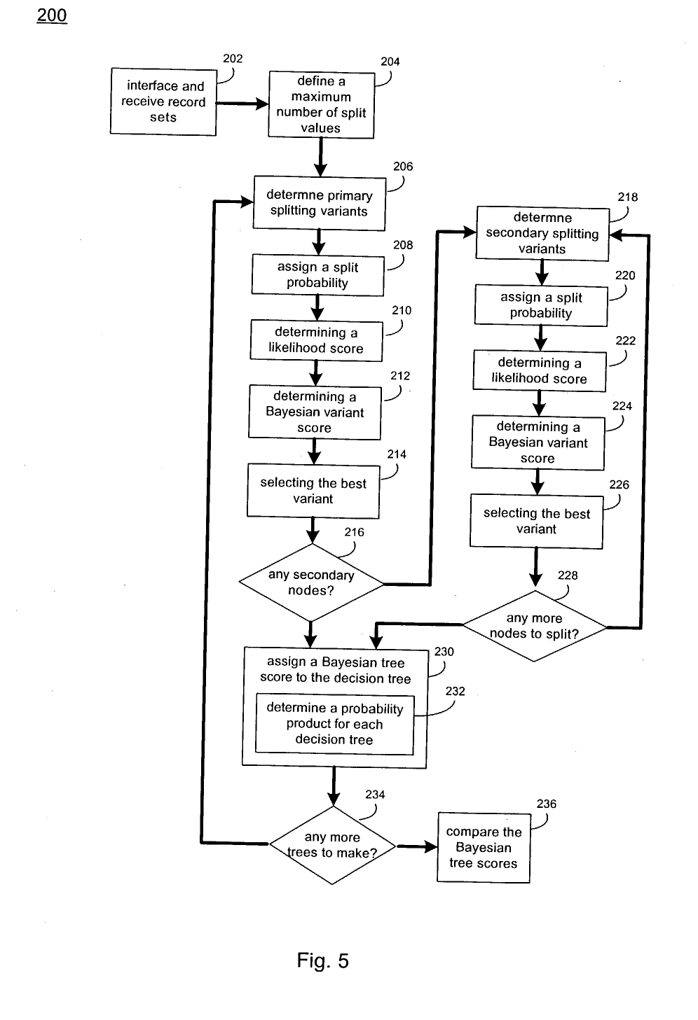

Referring to FIG. 5, a decision tree selection method 200 includes interfacing with a database and receiving record sets (202). The user may define a maximum number of split values for any of the input fields in the record sets (204).

Primary splitting variants are determined for the primary node and a Bayesian variant score is determined for each of these primary splitting variants (206). A split probability is assigned to each variant (208), and the split probability is used to determine a likelihood score for each variant (210). From the likelihood score and the probability, a Bayesian variant score is determined for each of the primary splitting variants (212), and the variant having the most desirable Bayesian score is selected (214).

If the tree being analyzed includes a secondary node (216), secondary splitting variants are determined for the secondary node and a Bayesian variant score is determined for each of the secondary splitting variants (218). A split probability is assigned to each variant (220), and the split probability is used to determine a likelihood score for each variant (222). From the likelihood score and the probability, a Bayesian variant score is determined for each of the secondary splitting variants (224), and the variant having the most-desirable Bayesian score is selected (226). If the tree includes additional secondary nodes (228), those nodes are analyzed.

If there are no additional secondary nodes, the tree is complete and a Bayesian tree score is assigned to the decision tree (230). Assigning the tree score includes determining a probability product for the decision tree (232). Once the Bayesian tree score is determined for the current tree being analyzed, the process repeats if there are additional trees to be analyzed (234).

If there are no additional decision trees to analyze, the Bayesian tree scores for the decision trees analyzed are compared (236) and the tree with the most desirable Bayesian tree score is selected (238). As discussed above, this may be the tree with the highest Bayesian score or a Bayesian score sufficiently high to satisfy a minimum Bayesian score requirement.

The described system is not limited to the implementations described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers, each of which includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled language or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Implementations of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Implementations of the system may also use integrated circuit blocks referred to as main memory, cache memory, or other types of memory that store electronic instructions to be executed by a microprocessor or store data that may be used in arithmetic operations.

A number of implementations have been described. Nevertheless, it will be understood that various modifications may be made. Accordingly, other implementations are within the scope of the following claims.

1. A method of selecting a decision tree from multiple decision trees, the method comprising:
assigning a Bayesian tree score to each of a plurality of decision trees, wherein at least one of the decision trees comprises at least a three way split for at least one node;
comparing the Bayesian tree score of each decision tree; and
selecting a decision tree based on the comparison of the Bayesian tree scores.

2. The decision tree selection method of claim 1 further comprising generating each of the decision trees from a common set of data.

3. The decision tree selection method of claim 2, wherein generating each of the decision trees includes generating a first decision tree based on a default value of one or more user-defined parameters.

4. The decision tree selection method of claim 3, wherein generating each of the decision trees further includes generating additional decision trees based on a non-default value of the one or more user-defined parameters.

5. The decision tree selection method of claim 3, wherein the one or more user-defined parameters are chosen from the group consisting of a node split probability, and a maximum split value.

6. The decision tree selection method of claim 1 further comprising receiving record sets, each of which includes at least one input factor and at least one determined output factor, wherein the record sets are used to generate the decision trees.

7. The decision tree selection method of claim 6 wherein the record sets are stored on a database and receiving record sets is configured to interface the decision tree selection method with the database.

8. The decision tree selection method of claim 6 wherein each decision tree includes a primary node, the decision tree selection method further comprising determining primary splitting variants for the primary node and a Bayesian variant score for each of the primary splitting variants.

9. The decision tree selection method of claim 8 wherein determining primary splitting variants includes assigning a primary split probability to each primary splitting variant.

10. The decision tree selection method of claim 9 wherein determining primary splitting variants further includes determining a likelihood score for each primary splitting variant.

11. The decision tree selection method of claim 10 wherein determining primary splitting variants further includes processing the likelihood score and primary split probability of each primary splitting variant to determine the Bayesian variant score for each primary splitting variant.

12. The decision tree selection method of claim 8 further comprising selecting the primary splitting variant having the most desirable Bayesian variant score.

13. The decision tree selection method claim 12 wherein the primary node is a primary leaf node, and assigning a Bayesian tree score includes determining, for a decision tree, a probability product that is equal to the probability of the selected primary splitting variant.

14. The decision tree selection method of claim 13 wherein assigning a Bayesian tree score includes determining, for a decision tree, the Bayesian tree score that is equal to the mathematical product of the probability product and the likelihood score of the primary leaf node.

15. The decision tree selection method of claim 12 wherein the primary node is a primary split node including branches.

16. The decision tree selection method of claim 15 further comprising defining a maximum number of split values for any input factor.

17. The decision tree selection method of claim 15 wherein one or more of the decision trees includes one or more secondary nodes, wherein each secondary node is connected to a branch of a superior node.

18. The decision tree selection method of claim 17 wherein the superior node is the primary node.

19. The decision tree selection method of claim 17 wherein the superior node is a superior secondary node.

20. The decision tree selection method of claim 17 further comprising determining secondary splitting variants for the secondary node and a Bayesian variant score for each of the secondary splitting variants.

21. The decision tree selection method of claim 20 wherein determining secondary splitting variants includes assigning a secondary split probability to each secondary splitting variant.

22. The decision tree selection method of claim 21 wherein determining secondary splitting variants further includes determining a likelihood score for each secondary splitting variant.

23. The decision tree selection method of claim 22 wherein determining secondary splitting variants further includes processing the likelihood score and secondary split probability of each secondary splitting variant to determine the Bayesian variant score for each secondary splitting variant.

24. The decision tree selection method of claim 20 further comprising selecting the secondary splitting variant having the most desirable Bayesian variant score.

25. The decision tree selection method of claim 24 wherein at least one secondary node is a secondary leaf node.

26. The decision tree selection method of claim 25 wherein assigning a Bayesian tree score includes determining, for a decision tree, a probability product that is equal to the mathematical product of the probabilities of the selected primary splitting variant and any selected secondary splitting variants.

27. The decision tree selection method of claim 26 wherein assigning a Bayesian tree score includes determining, for a decision tree, the Bayesian tree score that is equal to the mathematical product of the probability product and the likelihood score of each secondary leaf node.

28. The decision tree selection method of claim 24 wherein at least one secondary node is a secondary split node including branches.

29. The decision tree selection method of claim 28 further comprising defining a maximum number of split values for any input factor.

30. The decision tree selection method of claim 24 wherein the superior node is the primary node and the secondary splitting variants excludes the primary splitting variant selected for the primary node.

31. The decision tree selection method of claim 24 wherein the superior node is a superior secondary node and the secondary splitting variants excludes the secondary splitting variant selected for the superior secondary node.

32. A computer program product residing on a computer readable medium having instructions stored thereon which, when executed by a processor, cause the processor to:
assign a Bayesian tree score to each of a plurality of decision trees, wherein at least one of the decision trees comprises at least a three way split for at least one node;
compare the Bayesian tree score of each decision tree; and
select a decision tree based on the comparison of the Bayesian tree scores.

33. The computer program product of claim 32 further comprising instructions to generate each of the decision trees from a common set of data.

34. The computer program product of claim 33, wherein generating each of the decision trees includes instructions to generate a first decision tree based on a default value of one or more user-defined parameters.

35. The computer program product of claim 34, wherein generating each of the decision trees further includes instructions to generate additional decision trees based on a non-default value of the one or more user-defined parameters.

36. The computer program product of claim 34, wherein the one or more user-defined parameters are chosen from the group consisting of a node split probability, and a maximum split value.

37. The computer program product of claim 32 further comprising instructions to receive record sets, each of which includes at least one input factor and at least one determined output factor, wherein the record sets are used to generate the decision trees.

38. The computer program product of claim 37 wherein the record sets are stored on a database and receiving record sets is configured to interface the computer program product with the database.

39. The computer program product of claim 37 wherein each decision tree includes a primary node, the computer program product further comprising instructions to determine primary splitting variants for the primary node and a Bayesian variant score for each of the primary splitting variants.

40. The computer program product of claim 39 wherein determining primary splitting variants includes instructions to assign a primary split probability to each primary splitting variant.

41. The computer program product of claim 40 wherein determining primary splitting variants further includes instructions to determine a likelihood score for each primary splitting variant.

42. The computer program product of claim 41 wherein determining primary splitting variants further includes instructions to process the likelihood score and primary split probability of each primary splitting variant to determine the Bayesian variant score for each primary splitting variant.

43. The computer program product of claim 39 further comprising instructions to select the primary splitting variant having the most desirable Bayesian variant score.

44. The computer program product claim 43 wherein the primary node is a primary leaf node, and assigning a Bayesian tree score includes instructions to determine, for a decision tree, a probability product that is equal to the probability of the selected primary splitting variant.

45. The computer program product of claim 44 wherein assigning a Bayesian tree score includes instructions to determine, for a decision tree, the Bayesian tree score that is equal to the mathematical product of the probability product and the likelihood score of the primary leaf node.

46. The computer program product of claim 43 wherein the primary node is a primary split node including branches.

47. The computer program product of claim 46 further comprising instructions to define a maximum number of split values for any input factor.

48. The computer program product of claim 46 wherein one or more of the decision trees includes one or more secondary nodes, wherein each secondary node is connected to a branch of a superior node.

49. The computer program product of claim 48 wherein the superior node is the primary node.

50. The computer program product of claim 48 wherein the superior node is a superior secondary node.

51. The computer program product of claim 48 further comprising instructions to determine secondary splitting variants for the secondary node and a Bayesian variant score for each of the secondary splitting variants.

52. The computer program product of claim 51 wherein determining secondary splitting variants includes instructions to assign a secondary split probability to each secondary splitting variant.

53. The computer program product of claim 52 wherein determining secondary splitting variants further includes instructions to determine a likelihood score for each secondary splitting variant.

54. The computer program product of claim 53 wherein determining secondary splitting variants further includes instructions to process the likelihood score and secondary split probability of each secondary splitting variant to determine the Bayesian variant score for each secondary splitting variant.

55. The computer program product of claim 51 further comprising instructions to select the secondary splitting variant having the most desirable Bayesian variant score.

56. The computer program product of claim 55 wherein at least one secondary node is a secondary leaf node.

57. The computer program product of claim 56 wherein assigning a Bayesian tree score includes instructions to determine, for a decision tree, a probability product that is equal to the mathematical product of the probabilities of the selected primary splitting variant and any selected secondary splitting variants.

58. The computer program product of claim 57 wherein assigning a Bayesian tree score includes instructions to determine, for a decision tree, the Bayesian tree score that is equal to the mathematical product of the probability product and the likelihood score of each secondary leaf node.

59. The computer program product of claim 55 wherein at least one secondary node is a secondary split node including branches.

60. The computer program product of claim 59 further comprising instructions to define a maximum number of split values for any input factor.

61. The computer program product of claim 55 wherein the superior node is the primary node and the secondary splitting variants excludes the primary splitting variant selected for the primary node.

62. The computer program product of claim 55 wherein the superior node is a superior secondary node and the secondary splitting variants excludes the secondary splitting variant selected for the superior secondary node.

63. A system for selecting a decision tree from multiple decision trees, the system including a processor configured to:
assign a Bayesian tree score to each of a plurality of decision trees, wherein at least one of the decision trees comprises at least a three way split for at least one node;
compare the Bayesian tree score of each decision tree; and
select a decision tree based on the comparison of the Bayesian tree scores.

64. The system of claim 63 further comprising instructions to generate each of the decision trees from a common set of data.

65. The system of claim 64, wherein generating each of the decision trees includes instructions to generate a first decision tree based on a default value of one or more user-defined parameters.

66. The system of claim 65, wherein generating each of the decision trees further includes instructions to generate additional decision trees based on a non-default value of the one or more user-defined parameters.

67. The system of claim 66, wherein the one or more user-defined parameters are chosen from the group consisting of a node split probability, and a maximum split value.

68. The system of claim 63 further comprising instructions to receive record sets, each of which includes at least one input factor and at least one determined output factor, wherein the record sets are used to generate the decision trees.

69. The system of claim 68 wherein the record sets are stored on a database and receiving record sets is configured to interface the computer program product with the database.
